(19) United States
(12) Patent Application Publication
(10) Pub. No.: US 2026/0195618 A1
(43) Pub. Date: Jul. 9, 2026

(54) TRAINING TEXT PROCESSING MODEL

(71) Applicant: TENCENT TECHNOLOGY (SHENZHEN) COMPANY LIMITED, Shenzhen (CN)

(72) Inventors: Wei LIU, Shenzhen (CN); Jie JIANG, Shenzhen (CN); Zhipeng YANG, Shenzhen (CN); Sirui GAO, Shenzhen (CN); Zongwei LI, Shenzhen (CN); Yeting HE, Shenzhen (CN); Yao DING, Shenzhen (CN); Guinan SU, Shenzhen (CN)

(73) Assignee: TENCENT TECHNOLOGY (SHENZHEN) COMPANY LIMITED, Shenzhen, GD (CN)

(21) Appl. No.: 19/552,648

(22) Filed: Feb. 27, 2026

Related U.S. Application Data
(63) Continuation of application No. PCT/CN2024/116277, filed on Sep. 2, 2024.

(30) Foreign Application Priority Data
Nov. 8, 2023 (CN) 202311484312.X

(51) Int. Cl. G06N 5/04; G06F 40/205; G06F 40/40

(52) U.S. Cl. CPC G06N 5/04; G06F 40/205; G06F 40/40

(57) ABSTRACT

In a method for training a text processing model, a sample text set is obtained. The sample text set includes a plurality of independent sample text and sample labels of the plurality of independent sample text. At least two independent sample text in the plurality of independent sample text are concatenated for each of a plurality of concatenated sample text. A plurality of concatenated sample features is obtained from the plurality of concatenated sample text through a text processing model. A feature corresponding to each independent sample text in the plurality of concatenated sample features is masked to obtain a plurality of predicted text. A loss function is determined based on differences between the plurality of predicted text and the sample labels. Parameter updating on the text processing model is performed based on the loss function.

### RELATED APPLICATIONS

The present application is a continuation of International Application No. PCT/CN2024/116277, filed on Sep. 2, 2024, which claims priority to Chinese Patent Application No. 202311484312.X, filed on Nov. 8, 2023. The entire disclosures of the prior applications are hereby incorporated by reference.

### FIELD OF THE TECHNOLOGY

This disclosure relates to the field of computers and artificial intelligence technologies, including to a method for training a text processing model, an apparatus for training a text processing model, an electronic device, a program product, and a storage medium.

### BACKGROUND OF THE DISCLOSURE

An artificial intelligence (AI) technology is a comprehensive discipline, and relates to a wide range of fields including both hardware technologies and software technologies. Basic artificial intelligence technologies may include a sensor, a dedicated artificial intelligence chip, cloud computing, distributed storage, a big data processing technology, a pre-trained model technology, an operating/interaction system, electromechanical integration, and the like. The pre-trained model is also referred to as a large model or a basic model, and may be widely applied to downstream tasks in various directions of artificial intelligence after fine tuning. Artificial intelligence software technologies mainly include several major directions such as a computer vision (CV) technology, a speech processing technology, a natural language processing technology, and machine learning/deep learning.

In the related technology, in a supervised fine-tuning phase of related large language models, training is usually performed by using models in a specific field. In a training process, different pieces of training text of a unified batch do not necessarily belong to a context with a correlation, resulting in poor generalization or a multi-round dialog capability of a text processing model obtained by batch training. In the related technology, a more effective method to improve the accuracy of the trained text processing model is needed.

### SUMMARY

Embodiments of this disclosure provide a method for training a text processing model, an apparatus for training a text processing model, an electronic device, a non-transitory computer-readable storage medium, and a computer program product, which can improve accuracy of text prediction performed by a trained text processing model.

An aspect of the disclosure provides a method for training a text processing model. In the method, a sample text set is obtained. The sample text set includes a plurality of independent sample text and sample labels of the plurality of independent sample text. At least two independent sample text in the plurality of independent sample text are concatenated for each of a plurality of concatenated sample text. A plurality of concatenated sample features is obtained from the plurality of concatenated sample text through the text processing model. A feature corresponding to each independent sample text in the plurality of concatenated sample features is masked to obtain a plurality of predicted text. A loss function is determined based on differences between the plurality of predicted text and the sample labels. Parameter updating on the text processing model is performed based on the loss function.

An aspect of this disclosure provides an information processing apparatus that includes processing circuitry. The processing circuitry is configured to obtain a sample text set. The sample text set includes a plurality of independent sample text and sample labels of the plurality of independent sample text. The processing circuitry is configured to concatenate at least two independent sample text in the plurality of independent sample text for each of a plurality of concatenated sample text. The processing circuitry is configured to obtain a plurality of concatenated sample features, through a text processing model, from the plurality of concatenated sample text. The processing circuitry is configured to mask a feature corresponding to each independent sample text in the plurality of concatenated sample features to obtain a plurality of predicted text. The processing circuitry is configured to determine a loss function based on differences between the plurality of predicted text and the sample labels. The processing circuitry is configured to perform parameter updating on the text processing model based on the loss function.

An aspect of this disclosure provides a non-transitory computer-readable storage medium storing instructions which when executed by at least one processor cause the at least one processor to perform a method for training a text processing model. In the method, a sample text set is obtained. The sample text set includes a plurality of independent sample text and sample labels of the plurality of independent sample text. At least two independent sample text in the plurality of independent sample text are concatenated for each of a plurality of concatenated sample text. A plurality of concatenated sample features is obtained from the plurality of concatenated sample text through the text processing model. A feature corresponding to each independent sample text in the plurality of concatenated sample features is masked to obtain a plurality of predicted text. A loss function is determined based on differences between the plurality of predicted text and the sample labels. Parameter updating on the text processing model is performed based on the loss function.

An aspect of this disclosure provides a method for training a text processing model, performed by an electronic device, the method including: obtaining a sample text set, the sample text set including a plurality of pieces of independent sample text and sample labels of the plurality of pieces of independent sample text; concatenating at least two pieces of independent sample text in the plurality of pieces of independent sample text, to obtain a plurality of pieces of concatenated sample text; invoking an initialized text processing model based on the plurality of pieces of concatenated sample text for feature extraction to obtain a plurality of concatenated sample features; invoking a mask attention mechanism based on each concatenated sample feature for prediction to obtain predicted text, the mask attention mechanism including: masking a feature corresponding to each independent sample text in the concatenated sample feature; determining a loss function based on a difference between the predicted text and the sample label; and performing parameter updating on the text processing model based on the loss function, to obtain a trained text processing model.

An aspect of this disclosure provides an apparatus for training a text processing model, including: a data obtaining module, configured to obtain a sample text set, the sample text set including a plurality of pieces of independent sample text and sample labels of the plurality of pieces of independent sample text, and the data obtaining module being configured to concatenate at least two pieces of independent sample text in the plurality of pieces of independent sample text, to obtain a plurality of pieces of concatenated sample text; and a model training module, configured to invoke an initialized text processing model based on the plurality of pieces of concatenated sample text for feature extraction to obtain a plurality of concatenated sample features, the model training module being configured to invoke a mask attention mechanism based on each concatenated sample feature for prediction to obtain predicted text, the mask attention mechanism including: masking a feature corresponding to each independent sample text in the concatenated sample feature, the model training module being configured to determine a loss function based on a difference between the predicted text and the sample label, and the model training module being configured to perform parameter updating on the text processing model based on the loss function, to obtain a trained text processing model.

An aspect of this disclosure provides an electronic device, including: a memory, configured to store computer executable instructions; and a processor, configured to implement, when executing the computer executable instructions stored in the memory, the methods for training the text processing model provided in the embodiments of this disclosure.

An aspect of this disclosure provides a computer-readable storage medium, such as a non-transitory computer-readable storage medium, having computer executable instructions stored therein, the computer executable instructions, when executed by a processor, cause the processor to implement the methods for training the text processing model provided in the embodiments of this disclosure.

An aspect of this disclosure provides a computer program product, including computer programs or computer executable instructions, the computer programs or the computer executable instructions, when executed by a processor, cause the processor to implement the methods for training the text processing model provided in the embodiments of this disclosure.

### The Aspects of this Disclosure Include the Following Beneficial Effects

In a process of training the model, the short independent sample text is concatenated into longer concatenated text, so that the richness of training samples is enhanced, the computation resources required for obtaining the training samples are conserved, and a multi-round dialog capability of the model and the accuracy of the trained text processing model are improved by using the concatenated text; the mask attention mechanism is employed for the concatenated sample feature of the concatenated text sample, and since the independent samples are unassociated, each independent sample text is masked based on the mask attention mechanism, so that the model better generalizes knowledge rules of language copies; and moreover, the text processing model has a good context parsing capability, and the accuracy of the text processing model is improved.

### BRIEF DESCRIPTION OF THE DRAWINGS

FIG. 1 is a schematic diagram of an application mode of a method for training a text processing model according to an embodiment of this disclosure.

FIG. 2 is a schematic structural diagram of an electronic device according to an embodiment of this disclosure.

FIG. 3A is a first schematic flowchart of a method for training a text processing model according to an embodiment of this disclosure.

FIG. 3B is a second schematic flowchart of a method for training a text processing model according to an embodiment of this disclosure.

FIG. 3C is a third schematic flowchart of a method for training a text processing model according to an embodiment of this disclosure.

FIG. 3D is a fourth schematic flowchart of a method for training a text processing model according to an embodiment of this disclosure.

FIG. 4 is a first schematic structural diagram of a text processing model according to an embodiment of this disclosure.

FIG. 5 is a second schematic structural diagram of a text processing model according to an embodiment of this disclosure.

FIG. 6 is a schematic structural diagram of an attention matrix according to an embodiment of this disclosure.

FIG. 7 is a schematic structural diagram of concatenated sample text according to an embodiment of this disclosure.

### DESCRIPTION OF EMBODIMENTS

To make the objectives, technical schemes, and advantages of this disclosure clearer, the following describes this disclosure in further detail with reference to the accompanying drawings. The described embodiments are not to be considered as a limitation to this disclosure. Other embodiments are within the scope of this disclosure.

In the following description, reference is made to “some embodiments” which describe a subset of all possible embodiments. However, “some embodiments” may be the same subset or different subsets of all possible embodiments and may be combined with each other without conflict.

In the following description, the terms “first”, “second”, and “third” are merely intended to distinguish between similar objects rather than describe specific orders. The terms “first”, “second”, and “third” may, where permitted, be interchangeable in a particular order or sequence, so that embodiments of this disclosure described herein may be performed in an order other than that illustrated or described herein.

In the following description of this disclosure, the use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Unless otherwise defined, meanings of all technical and scientific terms used in this specification are the same as those usually understood by a person skilled in the art to which this disclosure belongs. The examples of terms used herein are merely intended to describe objectives of the embodiments of this disclosure, and are not intended to limit this disclosure.

Before the embodiments of this disclosure are further described in detail, an example description is made on nouns and terms in the embodiments of this disclosure, and the nouns and terms in the embodiments of this disclosure are applicable to the following explanations. The descriptions of the terms are provided as examples only and are not intended to limit the scope of the disclosure.

(1) A transformer model (transformer) is a deep neural network model based on a self-attention mechanism, and is widely applied to various tasks in the field of natural language processing, such as text classification, machine translation, and a question-answering system. The model may transform an input sequence into an output sequence, and simultaneously retain important information in the input sequence. Because of excellent performance in processing long text, the transformer model is widely applied to the field of Chinese natural language processing. Compared with a related recurrent neural network (RNN) and a related convolutional neural network (CNN), the transformer model can perform parallel computation, thereby increasing a training speed. The transformer model is widely applied to tasks such as natural language processing, speech recognition, and image generation.

(2) Natural language processing (NLP) is an important direction in the computer science field and the artificial intelligence field. NLP studies various theories and methods that can implement effective communication between people and computers by using natural languages. The natural language processing relates to natural languages, namely, languages daily used by people, and is closely correlated to linguistics research; and at the same time, the natural language processing relates to important technologies for model training in the fields such as computer science, mathematics, and artificial intelligence. A pre-trained model is developed from a large language model (LLM) in the NLP field. After fine tuning, the large language model can be widely applied to downstream tasks. The natural language processing technologies may include technologies such as text processing, semantic understanding, machine translation, robot question-answering, and knowledge graph.

(3) A large language model (LLM) is a deep learning model trained by using a large amount of text data, and may generate natural language text or understand meanings of the language text. The large language model may process a plurality of natural language tasks, such as text classification, question answering, and dialog, and is an important approach to artificial intelligence.

(4) A normalization (Softmax) function is configured to convert output values of different categories into probability distributions with a range of [0, 1] and a sum of 1. A formula is as follows:

$$Softmax ( {Z}_{i} ) = \frac{{e}^{{Z}_{i}}}{{\sum }_{c = 1}^{C} {e}^{{Z}_{c}}} ,$$

where Zᵢ denotes an output value of an i^{th} node, and C denotes a quantity of output nodes, i.e., a quantity of classification categories.

(5) An attention mechanism is a neural network structure, and is configured to enable a model to “pay attention” to some particular portions when processing input information, and ignore other portions. In the fields of natural language processing, computer vision, and the like, the attention mechanism is widely configured to understand key information in text or an image, to improve performance and accuracy of the model. Essentially, the attention mechanism in deep learning is similar to a selective human visual attention mechanism. A core objective of the attention mechanism is to select more critical information for a current task objective from a large amount of information.

(6) Masking is a data processing technology, and controls visibility and availability of data by shielding or hiding some data. The masking is applied to the natural language processing and machine learning (ML). In the natural language processing, the masking is configured to control access of a model to particular words or characters in a text sequence. For example, the masking is employed in a language model to prevent the model from accessing future input data.

(7) Mask attention mechanism is an attention mechanism used in the natural language processing (NLP). The mask attention mechanism is applied to tasks such as machine translation, speech recognition, and language models. In the mask attention mechanism, a mask is a binary matrix whose size is the same as that of an input sequence, where 1 denotes a position that needs to be shielded, and 0 denotes a position that can be accessed. The mask is configured to shield some portions of the sequence, to ensure that the model does not employ future information to affect current prediction.

Embodiments of this disclosure provide a method for training a text processing model, an apparatus for training a text processing model, an electronic device, a computer-readable storage medium, and a computer program product, which can improve the accuracy of text prediction performed by a trained text processing model.

The following describes an example of an application of the electronic device provided in this embodiment of this disclosure. The electronic device provided in this embodiment of this disclosure may be implemented as a terminal device, such as a notebook computer, a tablet computer, a desktop computer, a set-top box, a smart television, a mobile device (for example, a mobile phone, a portable music player, a personal digital assistant, a dedicated messaging device, or a portable game device), an in-vehicle terminal, a virtual reality (VR) device, an augmented reality (AR) device, and various other types of user terminals, or may be implemented as a server. Examples of applications are described below when the electronic device is implemented as the terminal device or the server.

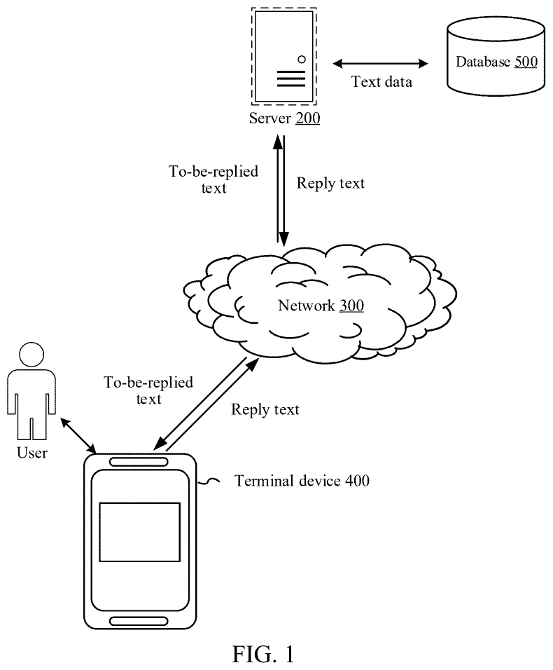

FIG. 1 is a schematic diagram of an application mode of a method for training a text processing model according to an embodiment of this disclosure. For example, a server 200, a network 300, a terminal device 400, and a database 500 are involved in FIG. 1. The terminal device 400 is connected to the server 200 via the network 300. The network 300 may be a wide area network or a local area network, or a combination of both.

In some embodiments, the database 500 is configured to store a large amount of text data, and the text data may be used as data for training the text processing model. The server 200 obtains a large amount of text data from the database as training data, and invokes the method for training the text processing model provided in the embodiments of this disclosure, to train the text processing model to obtain a trained model. A user enters to-be-replied text by using the terminal device 400, the terminal device 400 transmits the to-be-replied text to the server 200 by using the network 300, and the server 200 invokes the trained text processing model to perform text prediction on the to-be-replied text, to obtain reply text, and feeds back the reply text to the terminal device 400 by using the network 300.

In some embodiments, the text processing model trained by using the method for training the text processing model according to this embodiment of this disclosure may further be applied to the following application scenario: intelligent question answering. Reply content for a question inputted by the user is determined by invoking the text processing model trained according to the embodiments of this disclosure. The reply content may be in a plurality of fields such as news, education, and medical treatment.

This embodiment of this disclosure may be implemented by using a database technology. A database may be briefly considered as a place in which an electronic file cabinet stores electronic files. A user may perform operations such as adding, querying, updating, and deleting data in the files. The so-called “database” is data sets that are stored together in a particular manner, can be shared by multiple users, have least redundancy, and are independent of the disclosure.

A database management system (DBMS) is a computer software system designed for managing databases, and may have basic functions such as storage, interception, security guarantee, and backup. The database management system may be classified according to a supported database model such as a relational and an extensible markup language (XML); or classified according to a supported computer model, such as a server cluster or a mobile phone; or classified according to a used query language such as a structured query language (SQL) and XQuery; or classified according to a performance impulse focus such as a maximum scale and a highest running speed; or classified in another classification manner. Regardless of which classification manner is used, some DBMSs can fall into multiple categories at the same time, for example, supporting multiple query languages at the same time.

In some embodiments, the server 200 may include a training server and a text processing server. The training server is configured to train a text processing model, and the text processing server invokes the trained model to perform text prediction.

In some embodiments, the server may be an independent physical server, or may be a server cluster including multiple physical servers or a distributed system, or may be a cloud server providing basic cloud computing services, such as a cloud service, a cloud database, cloud computing, a cloud function, cloud storage, a network service, cloud communication, a middle-ware service, a domain name service, a security service, a content delivery network (CDN), big data, and an artificial intelligence platform. The electronic device may be a smart-phone, a tablet computer, a notebook computer, a desktop computer, a smart speaker, a smart-watch, or the like, but is not limited thereto. The terminal device may be connected directly or indirectly to the server in a wired or wireless communication mode. This is not limited in this disclosure.

In the following description of this disclosure, one or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

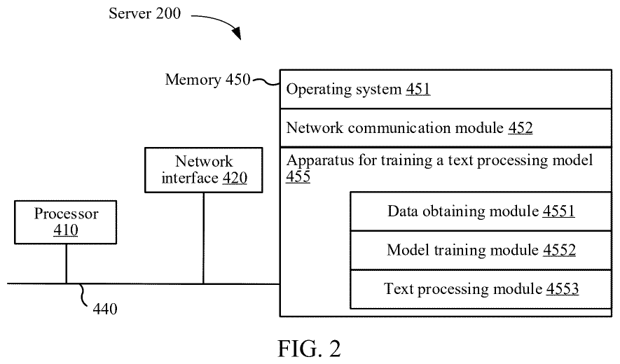

FIG. 2 is a schematic structural diagram of an electronic device according to an embodiment of this disclosure. The electronic device may be the server 200 shown in FIG. 1. The server 200 shown in FIG. 2 includes processing circuitry (for example, at least one processor 410), a memory 450, and at least one network interface 420. Components in the server 200 are coupled by a bus system 440. The bus system 440 is configured to implement connection and communication among these components. In addition to a data bus, the bus system 440 further includes a power bus, a control bus, and a state signal bus. However, for ease of clear description, all types of buses in FIG. 2 are marked as the bus system 440.

The processing circuitry (for example, processor 410) may be an integrated circuit chip with signal processing capacity such as a general processor, a digital signal processor (DSP), another programmable logic device, discrete gate or transistor logic device, or discrete hardware assembly, or the like. The general processor may be a microprocessor or any related processor, and the like.

The memory 450 may be removable, irremovable or a combination thereof. For example, the hardware device includes a solid memory, a hard disk drive, an optical disk drive, and the like. The memory 450 in some embodiments includes one or more storage devices that are physically located away from the processor 410.

The memory 450 includes a volatile memory or a non-volatile memory, or may include both the volatile memory and the non-volatile memory. The non-volatile memory may be a read only memory (ROM), and the volatile memory may be a random access memory (RAM). The memory 450 described in this embodiment of this disclosure aims at including any other suitable type of memories.

In some embodiments, the memory 450 can store data to support various operations. An example of these data includes a program, a module, and a data structure or a subset or a super-set thereof, which may be described below by way of example.

An operating system 451 includes system programs for processing various basic system services and executing hardware-related tasks, such as a frame layer, a core library layer, and a drive layer, and is configured to implement various basic services and process hardware-based tasks.

A network communication module 452 is configured to reach another electronic device through one or more (wired or wireless) network interfaces 420. For example, the network interfaces 420 include: Bluetooth, Wi-Fi, a universal serial bus (USB), and the like.

In some embodiments, the apparatus provided in this embodiment of this disclosure may be implemented by software. FIG. 2 shows an apparatus 455 for training a text processing model stored in a memory 450, which may be software in a form of a program and a plug-in, and includes a data obtaining module 4551, a model training module 4552, and a text processing module 4553. The modules are logical and may be combined in different manners or further split based on to-be-implemented functions. In FIG. 2, for ease of description, all the foregoing modules are shown at the same time. However, it is not to be considered that an implementation in which the apparatus 455 for training the text processing model may include only the data obtaining module 4551, and the model training module 4552. Functions of the modules are described below.

In some other embodiments, the apparatus for training the text processing model provided in this embodiment of this disclosure may be implemented by using hardware. For example, the apparatus for training the text processing model provided in this embodiment of this disclosure may be a processor in a form of a hardware decoding processor, programmed to perform the methods for training the text processing model provided in the embodiments of this disclosure. For example, the processor in the form of the hardware decoding processor may employ one or more application specific integrated circuits (ASICs), a digital signal processor (DSP), a programmable logic device (PLD), a complex programmable logic device (CPLD), a field-programmable gate array (FPGA), or other electronic components.

In some embodiments, the terminal or the server may implement the methods for training the text processing model provided in the embodiments of this disclosure by running a computer program. For example, the computer program may be a native program or a software module in an operating system; may be a native application (APP), namely, a program that needs to be installed in the operating system to run, such as a live streaming APP or an instant messaging APP; or may be a mini program, namely, a program that only needs to be downloaded into a browser environment to run; or may be a mini program that can be embedded in any APP. In general, the computer programs may be applications, modules, or plug-ins in any form.

The methods for training the text processing model provided in the embodiments of this disclosure are described with reference to the examples of applications and implementations of the server provided in this embodiment of this disclosure.

The following describes various methods for training a text processing model provided in the embodiments of this disclosure. As described above, an electronic device for implementing the methods for training the text processing model in the embodiments of this disclosure may be a terminal, a server, or a combination of both. Therefore, an execution module for performing each operation is not repeatedly described below.

In the following text processing example, a question-answering scenario and a translation scenario are used as examples for description. A person skilled in the art may apply, according to the following understanding, the methods for training the text processing model provided in the embodiments of this disclosure to processing of other scenarios in which text prediction needs to be performed, for example, copy resumption and intelligent assistant.

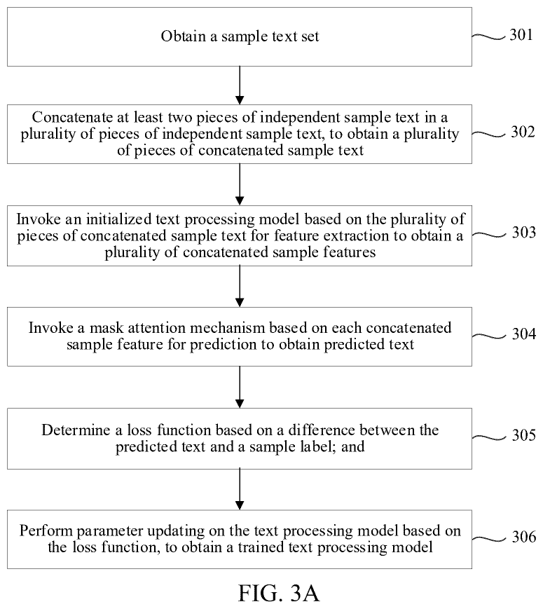

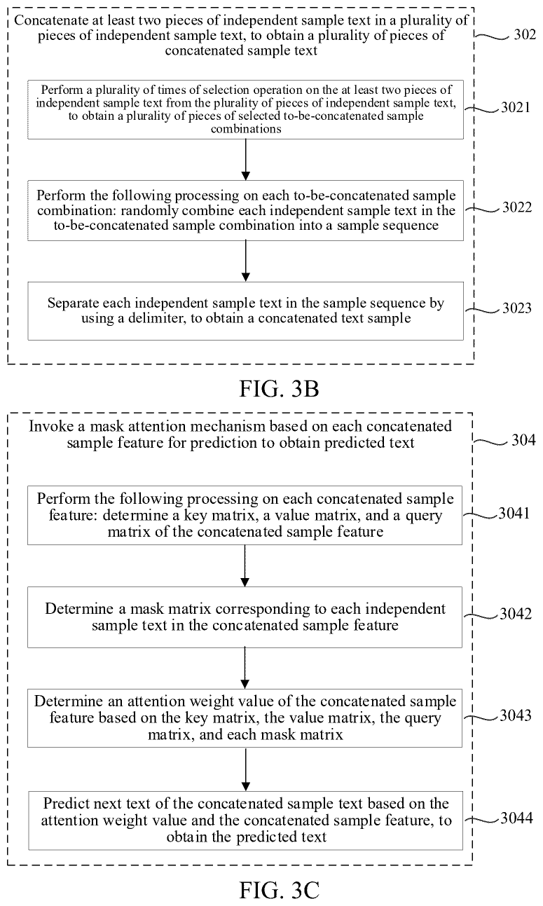

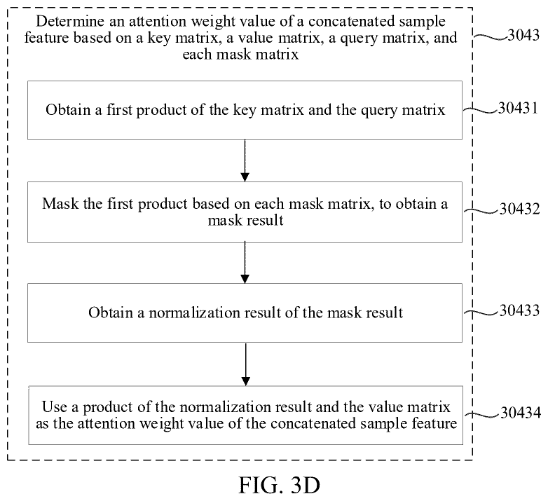

FIG. 3A is a first schematic flowchart of a method for training a text processing model according to an embodiment of this disclosure. The method is described in combination with operations shown in FIG. 3A.

Operation 301: Obtain a sample text set.

For example, the sample text set includes a plurality of pieces of independent sample text and sample labels of the plurality of pieces of independent sample text. In natural language processing (NLP), the independent sample text refers to text data that has no direct association or dependency relationship with each other. Each text sample is an object to be analyzed independently, and is not affected by another text sample. Content of the independent sample text may be unassociated or associated. Each independent sample text is a complete sentence or phrase. Each independent sample text represents an independent data point. The independent sample text may be classified or analyzed by using an algorithm.

For example, the text in the sample text set may be text crawled from a network, and the sample label includes output text corresponding to the independent sample text and a label probability corresponding to each character in the output text. For example, an application scenario of text processing is a Chinese-to-English translation scenario, and Chinese is “JIN TIAN TIAN QI ZEN ME YANG?(What's the weather like today?)”, the sample label includes English text translated from “JIN TIAN TIAN QI ZEN ME YANG?(What's the weather like today?)”, and the label probability of a character corresponding to each character position in the English text. The character position refers to a position of the character in the text. The output text may be preset or generated based on a trained model.

Operation 302: Concatenate at least two pieces of independent sample text in the plurality of pieces of independent sample text, to obtain a plurality of pieces of concatenated sample text.

For example, concatenation processing is to concatenate at least two pieces of text into one piece of text. The at least two pieces of text are completely concatenated in some embodiments. An object on which concatenation processing is performed is selected in various manners, a sequence of the sample text in the concatenated sample text can be random, and the concatenated sample text includes at least two pieces of independent sample text. The two pieces of concatenated sample text may have at least partially identical content, but the two pieces of concatenated sample text are not completely the same. For example, concatenated sample text 1 is formed by concatenating independent sample text 1 and independent sample text 2 in a sequential order; concatenated sample text 2 is formed by concatenating independent sample text 3 and the independent sample text 1 in a sequential order; and the concatenated sample text 1 and the concatenated sample text 2 both include the independent sample text 1, but the two are different from each other on the whole.

In some embodiments, FIG. 3B is a second schematic flowchart of a method for training a text processing model according to an embodiment of this disclosure. Operation 302 in FIG. 3A may be implemented through operations 3021 to 3023 in FIG. 3B, which are described below in detail.

Operation 3021: Perform a plurality of times of selection operations on at least two pieces of independent sample text from the plurality of pieces of independent sample text, to obtain a plurality of pieces of selected to-be-concatenated sample combinations.

For example, each to-be-concatenated sample combination includes at least two pieces of independent sample text. Each to-be-concatenated sample combination is different, and the selected independent sample text at each selection is at least partially distinct.

For example, it is assumed that the plurality of pieces of independent sample text includes independent sample text 1 to independent sample text N, N is a positive integer, selection is performed on the independent sample text 1 to the independent sample text N, a quantity of selected independent sample text at each selection is greater than or equal to 2, and the selected independent sample text at each selection is at least partially distinct. For example, a to-be-concatenated sample combination 1 is obtained at the first selection, and includes the independent sample text 1, independent sample text 3, and independent sample text 4. A to-be-concatenated sample combination 2 is obtained at the second selection, and includes the independent sample text 3, the independent sample text 4, and independent sample text 5. In the two to-be-concatenated sample combinations, at least some pieces of independent sample text are different.

Operation 3022: Perform the following processing on each to-be-concatenated sample combination: combine, in various manners (for example, randomly), each independent sample text in the to-be-concatenated sample combination into a sample sequence.

For example, random combinations may be implemented in the following manner: the independent sample text in the to-be-concatenated sample combination is sorted randomly to obtain a randomly-sorted sample sequence.

For example, still based on the foregoing example, the independent sample text in the to-be-concatenated sample combination is combined in random orders, to obtain a sample sequence [the independent sample text 3, the independent sample text 1, and the independent sample text 4].

Operation 3023: Separate each independent sample text in the sample sequence by using a delimiter, to obtain a concatenated text sample.

For example, content of the independent sample text is different, and is not necessarily associated. Different independent sample text is distinguished by using the delimiter. The delimiter is further referred to as a delimiter character, which is a special character configured to separate different portions in the text. Types of the delimiter include a space, a tab, a return/newline, a semicolon, a comma, a colon, a period/full stop, a query mark, a quotation mark, brackets, a hyphen, an underline, and the like.

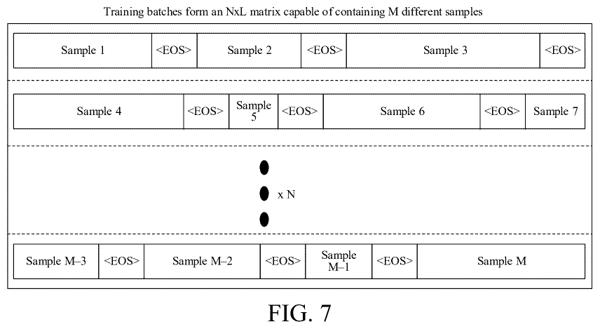

In this embodiment of this disclosure, a symbol <EOS> is used as an example for explanation and description. For example, content of the delimiter may be <EOS>, and in the natural language processing, <EOS> denotes an end of a sentence, and is used as a label for determining termination. After the delimiter is added to the sample sequence, the sample sequence is transformed into the concatenated text sample. Based on the foregoing example, the concatenated text sample is represented as [independent sample text 3<EOS> independent sample text 1<EOS> independent sample text 4]. FIG. 7 is a schematic structural diagram of concatenated sample text according to an embodiment of this disclosure. Samples 1 to M are concatenated in various manners to obtain N samples, M and N are positive integers, and M is greater than N. The samples are separated by using the delimiters.

In this embodiment of this disclosure, the independent sample text in the concatenated text is distinguished by using the delimiter, so that the text processing model is prevented from confusing context, and consequently, more attention is paid to learning features and modes of the text. In this way, a generalization capability of the text processing model can be improved, so that the text processing model has better performance on new data, and the accuracy of the trained text processing model can be improved. Different samples are concatenated into more and longer samples, so that computation resources required for obtaining the samples are conserved, content of training samples is enriched, a context understanding capability of the text processing model can be improved, and the accuracy of the text processing model can be improved.

Further refer to FIG. 3A. Operation 303: Invoke an initialized text processing model based on a plurality of pieces of concatenated sample text for feature extraction to obtain a plurality of concatenated sample features.

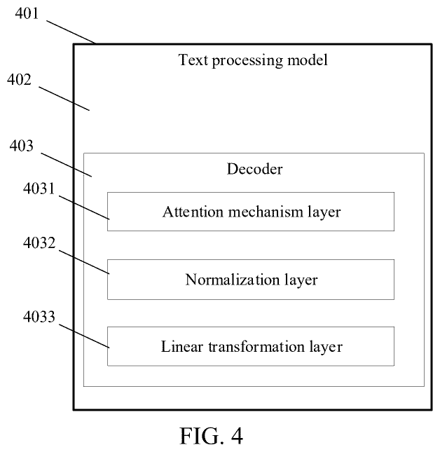

For example, the text processing model may be a transformer model, which is a deep neural network model based on a self-attention mechanism. FIG. 4 is a first schematic structural diagram of a text processing model according to an embodiment of this disclosure. The text processing model 401 includes an encoder 402 and a decoder 403, and the decoder 403 includes an attention layer 4031, a normalization layer 4032, and a linear transformation layer 4033. The encoder 402 is configured to perform feature extraction on text. The feature extraction of the text includes the following process: each character in the text is transformed into a token, and the tokens are combined into an embedding vector. The decoder 403 is configured to decode the embedding vector, to obtain a prediction result. The attention layer 4031 of the decoder 403 is configured to invoke a mask attention mechanism, the normalization layer 4032 is configured to perform normalization on an output result of the attention layer 4031, and the linear transformation layer 4033 is configured to transform a normalization result into the prediction result.

For example, feature extraction may be implemented in the following manner: the text processing model performs the following processing on each concatenated sample text: the encoder of the text processing model transforms each character in the concatenated sample text into a corresponding sequence number according to a vocabulary, to obtain text features in a sequence form, the vocabulary stores a mapping relationship between the sequence numbers and the characters, and the text features in the sequence form are normalized to obtain a concatenated sample feature in a feature vector form.

Operation 304: Invoke a mask attention mechanism based on each concatenated sample feature for prediction to obtain predicted text.

For example, the mask attention mechanism includes: masking a feature corresponding to each independent sample text in the concatenated sample feature. The mask attention mechanism refers to the processing of masking some information in an attention score matrix, which can improve the accuracy of attention computation.

In some embodiments, FIG. 3C is a third schematic flowchart of a method for training a text processing model according to an embodiment of this disclosure. Operation 304 in FIG. 3A may be implemented through operations 3041 to 3044 in FIG. 3C, which are described below in detail.

Operation 3041: Perform the following processing on each concatenated sample feature: determine a key matrix, a value matrix, and a query matrix of the concatenated sample feature.

For example, the attention mechanism is configured to obtain a weight, and configured to obtain a relationship between words by using a weight matrix. In this embodiment of this disclosure, keys, values, and queries are represented in a matrix form. In an actual application, the foregoing three may further be represented by vectors. The value matrix is configured to represent content of the concatenated sample feature, the query matrix is configured to represent a query target, and the key matrix is configured to represent queried content.

A process of an attention score Attention(Q, K, V) of the attention mechanism may be represented by the following formula (1):

$$Attention ( Q , K , V ) = softmax ( \frac{Q {K}^{T}}{\sqrt{{d}_{k}}} ) V \qquad ( 1 )$$

where softmax denotes a normalization function, and softmax may enable a sum of weight probability distributions to be 1.

$$\frac{{QK}^{T}}{\sqrt{{d}_{k}}}$$

denotes a raw score of attention, which represents a similarity score, and is obtained by using a dot product of the query matrix Q and the key matrix K. \sqrt{dₖ} denotes a scaling factor, which prevents a normalization result from being excessively large or excessively small, thereby avoiding a situation that the normalization result is either 0 or 1.

Operation 3042: Determine a mask matrix corresponding to each independent sample text in the concatenated sample feature.

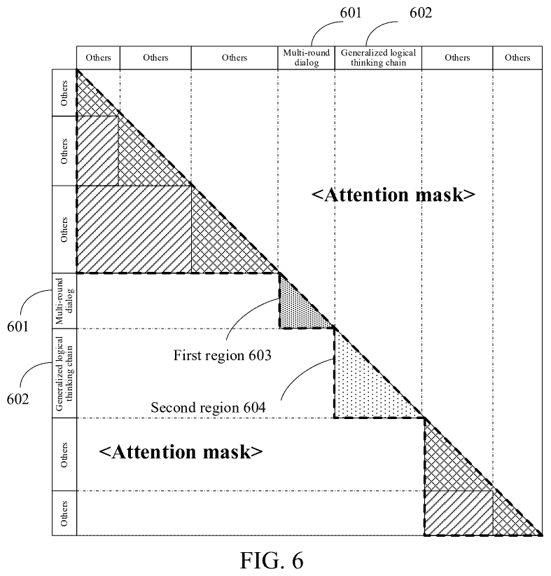

For example, the mask matrices for different types of independent sample text are different. To be specific, each independent sample text is masked according to the type. FIG. 6 is a schematic structural diagram of an attention matrix according to an embodiment of this disclosure. In the attention matrix, a feature of a multi-round dialog 601 is located in a first region 603, a feature of a generalized logical thinking chain 602 is located in a second region 604, and different types of independent sample text are masked separately. A blank portion in the attention matrix is a region corresponding to the attention mask. The multi-round dialog 601 and the generalized logical thinking chain 602 are of different types, and have respective mask matrices.

For example, when an attention weight value is represented by using the attention matrix, elements outside the mask matrix in the attention matrix are combined into a jagged pattern, and the elements located in a toothed portion of the jagged pattern are features of the independent sample text.

The jagged pattern formed by some elements in the matrix usually refers to a special structure of the matrix, and is referred to as a “jagged matrix” or a “segmented matrix”. Still referring to FIG. 6, the feature of the multi-round dialog 601 is located in the first region 603, and the first region 603 is one tooth of the jagged pattern. Each element in the mask matrix may be 0 or 1.

Operation 3043: Determine an attention weight value of the concatenated sample feature based on the key matrix, the value matrix, the query matrix, and each mask matrix.

For example, in this embodiment of this disclosure, a computation manner of a key value attention mechanism is used as an example for description. The attention weight value of the concatenated sample feature may be obtained by adding the mask matrix M based on the foregoing formula (1).

In some embodiments, FIG. 3D is a fourth schematic flowchart of a method for training a text processing model according to an embodiment of this disclosure. Operation 3043 in FIG. 3A may be implemented through operations 30431 to 30434 in FIG. 3D, which are described below in detail.

Operation 30431: Obtain a first product of the key matrix and the query matrix.

For example, description is continued based on the foregoing example of formula (1), and the first product of the key matrix and the query matrix is represented as: QK^{T}.

Operation 30432: Mask the first product based on each mask matrix, to obtain a mask result.

For example, in this embodiment of this disclosure, the computation manner of the key value attention mechanism is used as an example for description. The first product QK^{T} is masked, and an obtained mask result may be represented as QK^{T}M.

Operation 30433: Obtain a normalization result of the mask result.

For example, to prevent the normalization result from being excessively large or excessively small, a scaling factor \sqrt{dₖ}T may be set for the mask result. The obtained normalization result is represented as

$$softmax ( \frac{Q {K}^{T}}{\sqrt{{d}_{k}}} ) .$$

Operation 30434: Use a product of the normalization result and the value matrix as the attention weight value of the concatenated sample feature.

For example, operation 30434 may be represented as the following formula 2:

$$Attention ( Q , K , V ) = softmax ( \frac{Q {K}^{T} M}{\sqrt{{d}_{k}}} ) V \qquad ( 2 )$$

where Attention(Q, K, V) denotes the attention weight value.

Further refer to FIG. 3C. Operation 3044: Predict next text of the concatenated sample text based on the attention weight value and the concatenated sample feature, to obtain the predicted text.

For example, in the natural language processing, the next text usually refers to a next neighboring text segment subsequent to a piece of specified text. The concept is usually configured to process consecutive text sequences, such as consecutive words in a document, a paragraph, or a conversation. In this embodiment of this disclosure, the next text of the concatenated sample text refers to text obtained by processing the concatenated sample text according to a text processing task. The next text may have different content according to different text processing tasks. Details are described below.

The next text may have different content according to a specific application scenario of the text processing task. Taking an English-to-Chinese translation scenario is used as an example, it is assumed that the concatenated sample text is English, and the next text of the concatenated sample text is Chinese content corresponding to English content; taking a question-answering scenario as an example, it is assumed that the concatenated sample text is question information, and the next text of the concatenated sample text is reply content; and taking a text writing scenario as an example, the concatenated sample text is a keyword or a title, and the next text of the concatenated sample text is continuation content corresponding to the keyword or the title. In a prediction process, prediction is sequentially performed on each character or each word in the predicted text.

In some embodiments, operation 3044 may be implemented in the following manner: a plurality of first prediction probabilities of each character position in the next text of the concatenated sample text is predicted based on the attention weight value and the concatenated sample feature, where each first prediction probability corresponds to one candidate character; and the candidate character with a highest first prediction probability corresponding to each character position is used as a target character; and the target characters are combined according to an order of the character positions, to obtain the predicted text. At least one piece of predicted text may be obtained in the prediction process.

For example, the first prediction probability is a probability that a candidate character appears at a corresponding character position. An input of every i prediction processing may be a feature of the predicted target character, an attention weight value, and the concatenated sample feature. An output of every i prediction processing is the first prediction probability that a plurality of candidate characters appears at an (i+1)^{th} character position. The candidate character corresponding to the maximum first prediction probability is selected as an (i+1)^{th} target character.

In this embodiment of this disclosure, the mask attention mechanism is introduced to perform text prediction, so that the accuracy of text prediction performed by the text processing model can be improved. The mask attention mechanism can help the text processing model pay attention to a local feature of the text, and a generalization capability of the text processing model is improved, so that the text processing model has higher accuracy on new data that has not been seen.

Still refer to FIG. 3A. Operation 305: Determine a loss function based on a difference between the predicted text and a sample label.

For example, the loss function that measures the difference between the predicted text and the sample label may be a relative entropy loss function or a vector spatial distance function. The vector spatial distance function employs a spatial distance between two groups of probability vectors as a loss value. The relative entropy loss function is configured to measure a difference between two probability distributions.

In some embodiments, each sample label includes label probability sequences of output text corresponding to a plurality of pieces of independent sample text. Operation 305 may be implemented in the following manner: the first prediction probability corresponding to each character in the predicted text is obtained; and the first prediction probabilities are combined into a prediction probability sequence; the prediction probability sequence and the label probability sequence are represented as vectors respectively; and a vector spatial distance between the two vectors is used as the loss function.

For example, the label probability sequence is represented as a vector P, the prediction probability sequence is represented as a vector Q, a difference vector between the vector P and the vector Q is obtained, a total sum of squares of values of dimensions in the difference vector is obtained, and a square root is extracted from the total sum, to obtain a value of the loss function.

In this embodiment of this disclosure, the vector spatial distance between a real sample label and the predicted text is employed as the loss function, so that the interpretability of the loss function is improved, a difference between the predicted data and real data can be intuitively represented, and the generalizability of the text processing model is improved.

In some embodiments, each sample label includes: a label probability of each character in the output text corresponding to a plurality of pieces of independent sample text. Operation 305 may be implemented in the following manner: the first prediction probability corresponding to each character in the predicted text is obtained; and the following processing is performed on each character position: a ratio of the label probability of the character position to the first prediction probability is obtained; a second product of a logarithm of the ratio and the label probability is obtained; and a sum of the second products at the character positions is used as the loss function.

For example, a relative entropy (KL divergence) is an (asymmetric) measurement index configured to measure similarity of two probability distributions. The loss function may be represented by the following formula (3):

$${D}_{K L} ( p \vert \vert q ) = {\sum }_{i = 1}^{n} p ( {x}_{i} ) log ( \frac{p ( {x}_{i} )}{q ( {x}_{i} )} ) \qquad ( 3 )$$

where p(xᵢ) denotes a distribution of label probabilities, q(xᵢ) denotes a distribution of the first prediction probability, and the second product is

$$p ( {x}_{i} ) log ( \frac{p ( {x}_{i} )}{q ( {x}_{i} )} ) ,$$

and D_{KL} (p∥q) denotes a value of the relative entropy loss function. The smaller loss value indicates that p(xᵢ) is more approximate to q(xᵢ), and an effect of the text processing model is better.

In this embodiment of this disclosure, the relative entropy may effectively measure the difference between two probability distributions, namely, a degree of inconsistency between a real distribution and a model predicted distribution, so that the relative entropy loss function has robustness for a data set with imbalanced categories. The text processing model is trained by using the relative entropy loss function, so that the generalizability of the text processing model for different types of text and the accuracy of text processing can be improved.

Operation 306: Perform parameter updating on the text processing model based on the loss function, to obtain a trained text processing model.

For example, the parameter updating may be implemented through back propagation based on the loss function, and the parameter updating may be performed iteratively. Back propagation is an algorithm for computing a parameter gradient in a neural network. The back propagation computes a gradient of the loss function with respect to each parameter by using a chain rule, which facilitates the use of gradient descent or another optimization algorithm to update network parameters, so that the value of the loss function is minimized. The back propagation may be implemented in the following manner: a gradient of each layer is inversely computed from an output layer of the text processing model (an output layer of the decoder of the text processing model in this embodiment of this disclosure) by using the chain rule. For each weight, a gradient of the weight with respect to the loss function is computed in the following manner: a gradient of a next input node is multiplied by a gradient from the next input node to the current layer. The foregoing computation process is repeated until an input layer of the text processing model is computed. Parameters of each layer of the text processing model are updated based on the computed gradient, to obtain the trained text processing model.

In this embodiment of this disclosure, the independent sample text is concatenated to obtain the concatenated text as the training data, so that the richness of the samples is enhanced, and the computation resources required for obtaining the samples are conserved. The concatenated text includes different independent sample text, so that the context understanding capability of the text processing model can be improved, and the accuracy of the text processing model can be improved. In the training process, the mask attention mechanism is introduced to improve the generalization capability of the text processing model, so that the text processing model has higher accuracy on new data that has not been seen.

In some embodiments, after the operation 306, the following processing may be performed: in response to receiving the to-be-replied text of the target object, a historical reply text for the target object is obtained; the to-be-replied text and the historical reply text are concatenated into concatenated text; and the text processing model is invoked based on the concatenated text to perform text prediction, to obtain the current reply text, where the current reply text is reply content of the to-be-replied text.

For example, the target object may be a terminal device or an account used by a user. The server is used as an execution body. Descriptions are provided below with reference to a specific application scenario. It is assumed that the user is not a new user. The user uses the terminal device to access an intelligent question-answering platform. In response to receiving a question request carrying an account identifier corresponding to the user and the to-be-replied text, historical question content of the account corresponding to the account identifier is obtained, the to-be-replied text and historical reply text are concatenated into the concatenated text, and the reply text is fed back to the user with reference to the current to-be-replied content and the historical reply content. For example, the historical reply text is a copy with a specific language style. The new reply text is determined according to the to-be-replied text inputted by the user and the historical reply text. The new reply text has the same aforementioned specific language style. For another example, when the to-be-replied text is further question information about the historical reply text, new reply text is determined according to the to-be-replied text inputted by the user and the historical reply text. The new reply text is detailed content of the historical reply text according to the question information.

In this embodiment of this disclosure, the historical reply content and the to-be-replied text are concatenated, so that by fully using the context, different segments of content of the reply text outputted by the text processing model may be associated (for example, language styles are the same, and the content is partially identical), the accuracy of copy content outputted by the text processing model is improved, and the user experience is enhanced.

In this embodiment of this disclosure, in a process of training the model, the short independent sample text is concatenated into longer concatenated text, so that the richness of training samples is enhanced, the computation resources required for obtaining the training samples are conserved, and a multi-round dialog capability of the model and the accuracy of the trained text processing model are improved by using the concatenated text; the mask attention mechanism is employed for the concatenated sample feature of the concatenated text sample, and since the independent samples are unassociated, each independent sample text is masked based on the mask attention mechanism, so that the model better generalizes knowledge rules of language copies; and moreover, the text processing model has a good context parsing capability, and the accuracy of the text processing model is improved.

The following describes an example of an application of the method for training the text processing model in this embodiment of this disclosure in an actual application scenario.

In a related supervised fine-tuning phase of the large language model, different samples are concatenated into a same batch for training, which brings different attention mask mechanisms. In a related supervised fine-tuning method for a generated large language model, the self-attention mechanism is usually employed. Because of a self-regressive generation characteristic of the self-attention mechanism, a token at any position in a self-attention matrix is only affected by a previous token at the position. Therefore, a lower triangular matrix mask mechanism is employed to implement this characteristic, namely, a next token is invisible to the previous token.

During the fine tuning of the large language model, a training batch is formed by concatenating a plurality of training samples, and the samples are independent of each other before. In the related art, two solutions may be employed to deal with this case: first, an entire batch is considered as a complete whole, or considered as a completely independent sample. Using a lower triangular matrix mask may lead to a loss of a context capability of the model when multiple samples are considered as a single sample, namely, the context is neglected, and more attention is paid to a closer token, which may weaken the multi-round dialog capability. Second, a plurality of small lower triangular matrix masks is concatenated along a diagonal line according to the quantity of samples to form a batch attention matrix. When multiple samples are treated as completely independent samples, the attention is focused on fine segregation based on a sample granularity, which may lead to model over-fitting, resulting in a decline in the model generalization capability and context anti-interference capability.

The two related methods are incapable of performing tailored optimization of the attention mask according to the sample information, consequently yielding in insufficient model generalization capability or inadequate contextual understanding capability. In the related art, the large language model is lacking an appropriate attention mechanism for the supervised fine tuning. To resolve this problem, a key technical point of this embodiment of this disclosure is to employ a dynamic jagged attention mechanism to perform supervised fine tuning on the large language model.

In this embodiment of this disclosure, the current attention mechanism may be effectively optimized, so that efficiency of training the large language model and the text processing accuracy are improved. The method for training the text processing model provided in this embodiment of this disclosure employs the dynamic jagged attention mechanism, and determines whether to perform attention segregation according to categories of samples in a batch. Specifically, for NLP language samples (such as text generation, and fundamental NLP samples), jagged attention random concatenation is performed on the samples, so that the model better generalizes the knowledge rule of the language copy. For logical samples (such as reasoning mathematical samples, and multi-round dialog samples), the independent sample jagged attention is reserved, and the model focuses on learning deep logical dependencies.

The method for training the text processing model provided in this embodiment of this disclosure is described below.

For example, to improve the training efficiency, different samples in a training batch may be concatenated randomly. FIG. 7 is a schematic structural diagram of concatenated sample text according to an embodiment of this disclosure. Samples 1 to M are concatenated randomly to obtain N samples. The samples are separated by using delimiters. Different samples have independent semantic space, namely, the samples do not have a contextual semantic association with each other. An attention score between the independent samples is set to zero, and only internal local self-attention of the independent samples is reserved.

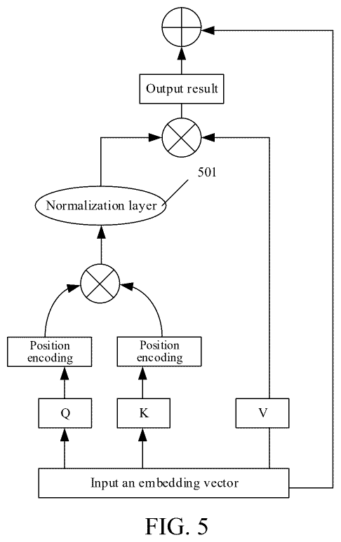

FIG. 5 is a second schematic structural diagram of a text processing model according to an embodiment of this disclosure. FIG. 5 is a structural diagram of modules corresponding to an attention mechanism in the text processing model. A query matrix Q, a key matrix K, and a value matrix V are generated based on an input embedding vector (the aforementioned concatenated text feature). The query matrix Q and the key matrix K are separately position-encoded and then multiplied, a product is normalized by a normalization layer 501, and a normalization result is multiplied with the value matrix V, to obtain an output result.

A process of an attention score Attention(Q, K, V) of the attention mechanism may be represented by the following formula (1):

$$Attention ( Q , K , V ) = softmax ( \frac{Q {K}^{T}}{\sqrt{{d}_{k}}} ) V \qquad ( 1 )$$

where softmax denotes a normalization function, and softmax may enable a sum of weight probability distributions to be 1.

$$\frac{{QK}^{T}}{\sqrt{{d}_{k}}}$$

denotes a raw score of attention, which represents a similarity score, and is obtained by using a dot product of the query matrix Q and the key matrix K. \sqrt{dₖ} denotes a scaling factor, which prevents a normalization result from being excessively large or excessively small, thereby avoiding a situation that the normalization result is either 0 or 1. When an attention map (N*N) is computed from QK^{T}, different attention mechanisms may be implemented by adding different mask matrices (N*N). The following explains each attention mechanism:

(1) A standard attention mask may be obtained by using a lower triangular matrix (N*N) in a matrix of the attention score.

(2) Low-rank lower triangular matrices with a sample granularity are added, and concatenated along a diagonal line into a complete N*N matrix, to obtain a sample-independent attention mask. Because the concatenated low-rank lower triangular matrix visually exhibits a jagged pattern, the attention mask is referred to as a sample-independent jagged attention mask.

(3) Different attention masks are employed for different samples according to category information of the samples, and are concatenated along a diagonal line into a complete N*N matrix, to obtain a dynamic jagged attention mask. FIG. 6 is a schematic structural diagram of an attention matrix according to an embodiment of this disclosure. In the attention matrix, a feature of a multi-round dialog 601 is located in a first region 603, and a feature of a generalized logical thinking chain 602 is located in a second region 604. A blank portion in the attention matrix is a region corresponding to the attention mask. Namely, a portion outside the region corresponding to the mask is in a jagged shape. After the attention mask is added, an attention computation manner may be rewritten as the following formula (2):

$$Attention ( Q , K , V ) = softmax ( \frac{Q {K}^{T} M}{\sqrt{{d}_{k}}} ) V \qquad ( 2 )$$

where M denotes the attention mask.

With continuous development of artificial intelligence technologies, intelligent assistants based on large language models have gradually become invaluable assistants both in daily life and work. Application scenarios and functions of the intelligent assistants are increasingly rich from smart-phones, televisions, and automobiles to various software applications. An improvement in a capability of the large language model may bring enhancement of experience in products. In a scenario of the large language model, a text processing model trained by using the method for training the text processing model provided in this embodiment of this disclosure may bring a better generalization capability, a better multi-round dialog capability, and a better logical reasoning capability. Based on the improvement in these capabilities, the intelligent assistant based on the trained text processing model may be applied to the following application scenarios:

(1) Intelligent customer service: in the field of customer service, the intelligent assistant may replace the related customer service personnel to provide users with 24-hour online service every day. By using the natural language processing technology, the intelligent assistant may understand questions of the users, and provide corresponding answers. This not only improves customer service efficiency, but also reduces manpower costs of enterprises. For example, the intelligent assistant is applied to the intelligent customer service in industries such as banks, telecommunications, and E-commerce.

(2) Personal assistant: in the field of personal life, the intelligent assistant has gradually become an intimate assistant of people. The intelligent assistants may help the users manage a schedule, remind them of important matters, query information, perform shopping, and the like. Furthermore, the intelligent assistants may further interact with another intelligent device, to implement a more convenient personal life.

(3) Educational tutoring: in the field of education, the intelligent assistant may provide students with personalized learning tutoring, answer questions, and enhance the learning efficiency of the students. By using an adaptive learning technology, the intelligent assistant is capable of recommending appropriate learning resources and practice exercises to the students based on their individual learning progress and abilities. In addition, the intelligent assistant may further cooperate with teachers to assist the teacher in completing student management and teaching tasks.

(4) Medical consultation: in the field of medical treatment, the intelligent assistant may provide users with services such as health consultation, medicine information query, and disease diagnosis. For example, by analyzing a large amount of medical literature and cases, the intelligent assistant may provide auxiliary diagnostic suggestions to doctors and provide psychological counseling to patients to help alleviate their mental stress.

(5) News pushing: in the field of news, the intelligent assistant may push personalized news information according to the interests and preferences of users. By analyzing a browsing history and behavior data of a user, the intelligent assistant can provide a tailored news reading environment to the user. In addition, the intelligent assistant is further capable of delivering news through voice broadcast, enabling users to keep abreast of current affairs during their hectic daily lives.

In this embodiment of this disclosure, for natural language processing (NLP) language samples (such as text generation, and fundamental NLP samples), jagged attention random concatenation is performed on the samples, so that the model better generalizes a knowledge rule of a language copy. For logical samples (such as reasoning mathematical samples and multi-round dialog samples), the independent sample jagged attention is reserved. For logical samples (such as reasoning mathematical samples, and multi-round dialog samples), the independent sample jagged attention is reserved, and the text processing model focuses on learning deep logical dependencies. Based on rigorous manual evaluation, the large language text processing model trained by using the method provided in this embodiment of this disclosure has superior overall performance in aspects such as the natural language processing basic capability, the multi-round dialog capability, the field application capability, the reasoning capability, and the text generation capability compared to the text processing model trained based on the related methods.

The following continues to describe an example of a structure of an apparatus 455 for training a text processing model provided in this embodiment of this disclosure that is implemented as software modules. In some embodiments, as shown in FIG. 2, the software modules in the apparatus 455 for training the text processing model stored in a memory 450 may include: a data obtaining module 4551, configured to obtain a sample text set, where the sample text set includes a plurality of pieces of independent sample text and sample labels of the plurality of pieces of independent sample text, and the data obtaining module 4551 is configured to concatenate at least two pieces of independent sample text in the plurality of pieces of independent sample text, to obtain a plurality of pieces of concatenated sample text; and a model training module 4552, configured to invoke the initialized text processing model based on the plurality of pieces of concatenated sample text for feature extraction to obtain a plurality of concatenated sample features, the model training module 4552 being configured to invoke a mask attention mechanism based on each concatenated sample feature for prediction to obtain predicted text, the mask attention mechanism including separately masking a feature corresponding to each independent sample text in the concatenated sample feature, the model training module 4552 being configured to determine a loss function based on a difference between the predicted text and the sample label, and the model training module 4552 being configured to perform parameter updating on the text processing model based on the loss function, to obtain a trained text processing model.

In some embodiments, the data obtaining module 4551 is configured to perform a plurality of times of selection operation on at least two pieces of independent sample text from the plurality of pieces of independent sample text, to obtain a plurality of selected to-be-concatenated sample combinations, where each to-be-concatenated sample combination includes the at least two pieces of independent sample text; and perform the following processing on each to-be-concatenated sample combination: in various manners combine each independent sample text in the to-be-concatenated sample combination into a sample sequence; and separate each independent sample text in the sample sequence by using a delimiter, to obtain a concatenated text sample.

In some embodiments, the model training module 4552 is configured to perform the following processing on each concatenated sample feature: determine a key matrix, a value matrix, and a query matrix of the concatenated sample feature; determine a mask matrix corresponding to each independent sample text in the concatenated sample feature; determine an attention weight value of the concatenated sample feature based on the key matrix, the value matrix, the query matrix, and each mask matrix; and predict next text of the concatenated sample text based on the attention weight value and the concatenated sample feature, to obtain the predicted text.

In some embodiments, the model training module 4552 is configured to obtain a first product of the key matrix and the query matrix; mask the first product based on each mask matrix, to obtain a mask result; obtain a normalization result of the mask result; and uses a product of the normalization result and the value matrix as the attention weight value of the concatenated sample feature.

In some embodiments, the mask matrices for different types of independent sample text are different.

In some embodiments, when the attention weight value is represented by using an attention matrix, elements outside the mask matrix in the attention matrix are combined into a jagged pattern, and the elements located in a toothed portion of the jagged pattern are features of the independent sample text.

In some embodiments, the model training module 4552 is configured to predict a plurality of first prediction probabilities of each character position in the next text of the concatenated sample text based on the attention weight value and the concatenated sample feature, each first prediction probability corresponding to a candidate character; use the candidate character with a highest first prediction probability corresponding to each character position as a target character; and combine the target characters according to an order of the character positions, to obtain the predicted text.

In some embodiments, each sample label includes a label probability sequence of output text corresponding to each of the plurality of pieces of independent sample text; and the model training module 4552 is configured to obtain the first prediction probability corresponding to each character in the predicted text; combine the first prediction probabilities into a prediction probability sequence; represent the prediction probability sequence and the label probability sequence as vectors respectively; and use a vector spatial distance between the two vectors as the loss function.

In some embodiments, each sample label includes a label probability of each character in output text corresponding to each of the plurality of pieces of independent sample text; and the model training module 4552 is configured to obtain the first prediction probability corresponding to each character in the predicted text; and perform the following processing for each character position: obtain a ratio of the label probability of the character position to the first prediction probability; obtain a second product of a logarithm of the ratio and the label probability; and use a sum of the second products at the character positions as the loss function.

In some embodiments, a text processing module 4553 is configured to perform parameter updating on the text processing model based on the loss function, to obtain a trained text processing model, and then obtain historical reply text with respect to a target object in response to receiving to-be-replied text of the target object; concatenate the to-be-replied text and the historical reply text into concatenated text; and invoke the text processing model based on the concatenated text to perform text prediction, to obtain current reply text, the current reply text being reply content of the to-be-replied text.

An embodiment of this disclosure provides a computer program product, the computer program product including computer programs or computer executable instructions, the computer programs or the computer executable instructions being stored in a computer-readable storage medium. A processor of an electronic device reads the computer programs or the computer executable instructions from the computer-readable storage medium, and the processor executes the computer programs or the computer executable instructions, to cause the electronic device to perform the methods for training the text processing model described above in the embodiments of this disclosure.

An embodiment of this disclosure provides a computer-readable storage medium (for example, a non-transitory computer-readable storage medium) having computer executable instructions stored therein, having the computer executable instructions or computer programs stored therein, the computer executable instructions or the computer programs, when executed by a processor, causing the processor to perform the methods for training the text processing model provided in the embodiments of this disclosure, such as the method for training the text processing model shown in FIG. 3A.

In some embodiments, the computer-readable storage medium may be a memory such as a ferroelectric random access memory (FRAM), a read-only memory (ROM), a programmable ROM (PROM), an electrically programmable ROM (EPROM), an electrically erasable PROM (EEPROM), a flash memory, a magnetic surface memory, an optical disk, or a CD-ROM, or may be any device including one of or any combination of the foregoing memories.

In some embodiments, the computer executable instruction may be written in the form of a program, software, a software module, a script, or code according to a programming language (including a compiler or interpreter language or a declarative or procedural language) in any form, and may be deployed in any form, including an independent program or a module, a component, a subroutine, or another unit suitable for use in a computing environment.

As an example, the computer executable instruction may, but do not necessarily, correspond to a file in a file system, and may be stored in a part of a file that saves another program or other data. For example, the computer executable instruction may be stored in one or more scripts in a hypertext markup language (HTML) file, stored in a file that is specially configured for a program in discussion, or stored in a plurality of collaborative files (for example, stored in files of one or more modules, subprograms, or code parts).

As an example, the executable instructions may be deployed to be executed on an electronic device, or deployed to be executed on a plurality of electronic devices at the same location, or deployed to be executed on a plurality of electronic devices that are distributed in a plurality of locations and interconnected by using a communication network.

In conclusion, in the embodiments of this disclosure, in a process of training the model, the short independent sample text is concatenated into longer concatenated text, so that the richness of training samples is enhanced, the computation resources required for obtaining the training samples are conserved, and a multi-round dialog capability of the model and the accuracy of the trained text processing model are improved by using the concatenated text; the mask attention mechanism is employed for the concatenated sample feature of the concatenated text sample, and since the independent samples are unassociated, each independent sample text is masked based on the mask attention mechanism, so that the model better generalizes knowledge rules of language copies; and moreover, the text processing model has a good context parsing capability, and the accuracy of the text processing model is improved.

The foregoing descriptions are merely examples of embodiments of this disclosure, and are not intended to limit the scope of this disclosure. Any modification, equivalent replacement, or improvement made without departing from the spirit and scope of this disclosure shall fall within the scope of this disclosure.

What is claimed is:

1. A method for training a text processing model, comprising:
obtaining a sample text set, the sample text set including a plurality of independent sample text and sample labels of the plurality of independent sample text;
concatenating at least two independent sample text in the plurality of independent sample text for each of a plurality of concatenated sample text;
obtaining, through the text processing model, a plurality of concatenated sample features from the plurality of concatenated sample text;
masking a feature corresponding to each independent sample text in the plurality of concatenated sample features to obtain a plurality of predicted text;
determining a loss function based on differences between the plurality of predicted text and the sample labels; and
performing, by processing circuitry, parameter updating on the text processing model based on the loss function.

2. The method according to claim 1, wherein the concatenating comprises:
performing a plurality of selection operations of at least two independent sample text from the plurality of independent sample text, to obtain a plurality of selected to-be-concatenated sample combinations, each to-be-concatenated sample combination including the at least two independent sample text; and
for each to-be-concatenated sample combination,
combining each independent sample text in the respective to-be-concatenated sample combination into a sample sequence; and
separating each independent sample text in the sample sequence with a delimiter, to obtain a concatenated text sample.

3. The method according to claim 1, wherein the masking comprises:
for each concatenated sample feature,
determining a key matrix, a value matrix, and a query matrix of the respective concatenated sample feature;
determining a mask matrix corresponding to each independent sample text in the respective concatenated sample feature;
determining an attention weight value of the respective concatenated sample feature based on the key matrix, the value matrix, the query matrix, and each mask matrix; and
predicting next text of the concatenated sample text corresponding to the respective concatenated sample feature based on the attention weight value and the respective concatenated sample feature, to obtain the predicted text corresponding to the respective concatenated sample feature.

4. The method according to claim 3, wherein the determining the attention weight value of the concatenated sample feature comprises:
obtaining a first product of the key matrix and the query matrix;
masking the first product based on each mask matrix, to obtain a mask result;
obtaining a normalization result of the mask result; and
obtaining the attention weight value of the concatenated sample feature based on a product of the normalization result and the value matrix.

5. The method according to claim 3, wherein mask matrices of different types of the independent sample text are different.

6. The method according to claim 3, wherein when the attention weight value is represented by an attention matrix, elements outside the mask matrix in the attention matrix are combined into a jagged pattern, and elements located in a toothed portion of the jagged pattern are features of the independent sample text.

7. The method according to claim 3, wherein the predicting comprises:
predicting a plurality of first prediction probabilities of each character position in the next text of the concatenated sample text corresponding to the respective concatenated sample feature based on the attention weight value and the respective concatenated sample feature, each first prediction probability corresponding to one candidate character;
obtaining a target character based on the candidate character with a highest first prediction probability corresponding to each character position; and
combining the target characters according to an order of the character positions, to obtain the predicted text corresponding to the respective concatenated sample feature.

8. The method according to claim 7, wherein each sample label includes a label probability sequence of output text corresponding to each of the plurality of independent sample text; and
the determining the loss function comprises:
obtaining the first prediction probability corresponding to each character in the predicted text;
combining the first prediction probabilities into a prediction probability sequence;
representing the prediction probability sequence and the label probability sequence as vectors respectively; and
obtaining the loss function based on a vector spatial distance between the two vectors.

9. The method according to claim 8, wherein each sample label includes a label probability of each character in the output text corresponding to each of the plurality of independent sample text; and
the determining the loss function comprises:
obtaining the first prediction probability corresponding to each character in the predicted text; and
on each character position,
obtaining a ratio of the label probability at the respective character position to the first prediction probability;
obtaining a second product of a logarithm of the ratio and the label probability; and
obtaining the loss function based on a sum of the second products at the character positions.

10. The method according to claim 1, further comprising:
obtaining historical reply text for a target object in response to receiving to-be-replied text of the target object;
concatenating the to-be-replied text and the historical reply text into concatenated text; and
invoking the text processing model based on the concatenated text and performing text prediction to obtain current reply text, the current reply text being reply content of the to-be-replied text.

11. The method according to claim 1, wherein the text processing model includes an encoder and a decoder, the encoder being configured to perform a feature extraction process, the decoder including an attention layer, and the attention layer being configured to invoke a mask attention mechanism to perform a prediction process.

12. An information processing apparatus, comprising:
processing circuitry configured to:
obtain a sample text set, the sample text set including a plurality of independent sample text and sample labels of the plurality of independent sample text;
concatenate at least two independent sample text in the plurality of independent sample text for each of a plurality of concatenated sample text;
obtain, through a text processing model, a plurality of concatenated sample features from the plurality of concatenated sample text;
mask a feature corresponding to each independent sample text in the plurality of concatenated sample features to obtain a plurality of predicted text;
determine a loss function based on differences between the plurality of predicted text and the sample labels; and
perform parameter updating on the text processing model based on the loss function.

13. The information processing apparatus according to claim 12, wherein the processing circuitry is configured to:
perform a plurality of selection operations of at least two independent sample text from the plurality of independent sample text, to obtain a plurality of selected to-be-concatenated sample combinations, each to-be-concatenated sample combination including the at least two independent sample text; and
for each to-be-concatenated sample combination,
combining each independent sample text in the respective to-be-concatenated sample combination into a sample sequence; and
separating each independent sample text in the sample sequence with a delimiter, to obtain a concatenated text sample.

14. The information processing apparatus according to claim 12, wherein the processing circuitry is configured to:
for each concatenated sample feature,
determine a key matrix, a value matrix, and a query matrix of the respective concatenated sample feature;
determine a mask matrix corresponding to each independent sample text in the respective concatenated sample feature;
determine an attention weight value of the respective concatenated sample feature based on the key matrix, the value matrix, the query matrix, and each mask matrix; and
predict next text of the concatenated sample text corresponding to the respective concatenated sample feature based on the attention weight value and the respective concatenated sample feature, to obtain the predicted text corresponding to the respective concatenated sample feature.

15. The information processing apparatus according to claim 14, wherein the processing circuitry is configured to:
obtain a first product of the key matrix and the query matrix;
mask the first product based on each mask matrix, to obtain a mask result;
obtain a normalization result of the mask result; and
obtain the attention weight value of the concatenated sample feature based on a product of the normalization result and the value matrix.

16. The information processing apparatus according to claim 14, wherein mask matrices of different types of the independent sample text are different.

17. The information processing apparatus according to claim 14, when the attention weight value is represented by an attention matrix, elements outside the mask matrix in the attention matrix are combined into a jagged pattern, and elements located in a toothed portion of the jagged pattern are features of the independent sample text.

18. The information processing apparatus according to claim 14, wherein the processing circuitry is configured to:
predict a plurality of first prediction probabilities of each character position in the next text of the concatenated sample text corresponding to the respective concatenated sample feature based on the attention weight value and the respective concatenated sample feature, each first prediction probability corresponding to one candidate character;
obtain a target character based on the candidate character with a highest first prediction probability corresponding to each character position; and
combine the target characters according to an order of the character positions, to obtain the predicted text corresponding to the respective concatenated sample feature.

19. The information processing apparatus according to claim 18, wherein each sample label includes a label probability sequence of output text corresponding to each of the plurality of independent sample text, and the processing circuitry is configured to:
obtain the first prediction probability corresponding to each character in the predicted text;
combine the first prediction probabilities into a prediction probability sequence;
represent the prediction probability sequence and the label probability sequence as vectors respectively; and
obtain the loss function based on a vector spatial distance between the two vectors.

20. A non-transitory computer-readable storage medium storing instructions which when executed by at least one processor cause the at least one processor to perform a method for training a text processing model, the method comprising:
obtaining a sample text set, the sample text set including a plurality of independent sample text and sample labels of the plurality of independent sample text;
concatenating at least two independent sample text in the plurality of independent sample text for each of a plurality of concatenated sample text;
obtaining, through the text processing model, a plurality of concatenated sample features from the plurality of concatenated sample text;
masking a feature corresponding to each independent sample text in the plurality of concatenated sample features to obtain a plurality of predicted text;
determining a loss function based on differences between the plurality of predicted text and the sample labels; and
performing parameter updating on the text processing model based on the loss function.
